(19) United States
(12) Patent Application Publication
(10) Pub. No.: US 2007/0198426 A1
(43) Pub. Date: Aug. 23, 2007

(54) Method and apparatus for digital copyright exchange

(76) Inventor: James M. Yates, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/591,416

(22) PCT Filed: Mar. 4, 2005
(86) PCT No.: PCT/US05/07102

§ 371 Date: Sep. 1, 2006

Related U.S. Application Data
(60) Provisional application No. 60/550,465, filed on Mar. 4, 2004.

(51) Int. Cl. H04L 9/00

(52) U.S. Cl. 705/59; 705/51

(57) ABSTRACT

An apparatus and method for enabling commercial exchange of copyrighted digital media and other digital files (104) where there is a fee due to the owner (102), such as but are not limited to, music, movies, books, software, games and photos. This structure will compensate the copyright owner (102) and the seller or referrer (106) completely within the existing laws. For a fee, a service provider (100) verifies for all parties to a transaction that the transaction is legal and the file or digital media is correct and without faults, as well as the proper routing of payment to all properly represented parties. It is simply a structure that will operate as all exchanges do, to facilitate the legal transfer of assets and money.

### CROSS-REFERENCE TO RELATED APPLICATIONS

The present application claims priority to U.S. Provisional Patent Application Ser. No. 60/550,465, filed Mar. 4, 2004, the contents of which are expressly incorporated herein by reference.

### TECHNICAL FIELD

The present invention relates to systems and methods for the commercial exchange of digital media files, and in particular, to a system and method for the commercial exchange of digital media files in a secure manner ensuring authorized transactions and compensation payments to owners and authorized sellers.

### BACKGROUND ART

As in all industries, technology has reduced the cost factors and provided new avenues of production and commerce unavailable previously. The lower cost of producing and distributing digital media has begun to revolutionize the process in which movies and music are made as well as distributed and purchased.

Copyrighted material is being copied and shared through physical digital copies as shown in FIGS. 1A and 1B, and through Internet file transfers as shown in FIG. 2. This has been most prevalent in the illegal sharing of MP3 music data files converted from compact discs (CDs) or other original sources. As the number of high speed Internet connections has increased the ability to accomplish file transfers of larger files, such as movies from digital video discs (DVDs), has also become a target of illegal file sharing.

Copyrighted material owners retain the right to control the distribution of their copyrighted material. With the advent of digital material (either original or copied from the original) that generally loses no quality with each copy, and an inexpensive transmission facility within the Internet, file sharing has exploded in popularity. The Internet has also provided some identity protection to those pursuing illegal sharing.

The copyright holders have generally been unable to negotiate a secure method of providing digital material. This has led to a feeble cat and mouse game of securing and breaching security. The DMCA (Digital Millennium Copyright Act) of 1998 has been mostly ineffective in eliminating the problem. It provides for the legal individual copying of copyrighted digital material for personal use, such as back up. Many of the copies currently shared are of low quality as they are obtained from the analog output of the digital file and may be incomplete or from live performances recorded by the individual illegally. Current computer systems and legal software applications make it relatively inexpensive for the individual to copy a CD or DVD into a format that is compressed from the original with little or no loss. This allows the user to legally backup or transfer the files to the popular iPod® (Apple Computer, Inc., Cupertino, Calif., USA) music player or similar devices. Generally that same file can be shared with or downloaded by others also.

Apple Computer's iTunes®, which sells individual songs for small sums, has been very successful (selling over 70 million copies in less than 12 months) in beginning to reverse the illegal file sharing growth. There are several other services that are currently selling songs (delivered by downloading MP3 files) in this way. They include services that have been in this area for a while as well as the reincarnation of the Napster (Napster, LLC, Santa Clara, Calif., USA) service, which let the technological genie out of the bottle in this area. Even Wal-Mart has announced a service similar to iTunes®. Price competition has already begun to creep into the market place.

The primary goal of the copyright holders in their quest to eliminate illegal sharing of their digital works is to eliminate the peer-to-peer network operation's facilitation of file sharing. This area has won court cases under the general premise that the services, such as KaZa™, Bearshare® (Free Peers, Inc., West Palm Beach, Fla., USA) and the like, only provide the software for sharing. Since they are not in the loop, or central to the transaction process, as Napster was, they are not responsible for or able to identify any of the activity of their application customers. Litigation is still being pursued in this area. Other cases being pursued attempt to hold the ISP (Internet Service Provider) responsible for user identification. These have only had limited success so far. All this is very expensive for all parties, particularly the copyright holder or his legal agents.

Another area that this process has exposed is the difficulties with the contracts between the music labels and the music performer and songwriter. Generally it is shown that the music label takes the majority of the gross income leaving small or no money for the party who initially provided the creative element. The contracts are restrictive, and it has been difficult for originators to be heard or seen without the label or studio connection. The distribution on the Internet has provided an avenue for anyone to expose their material without the restrictions and higher cost previously endured.

There is one additional important aspect of this issue. The copyright holders claim large amounts of lost sales based on the amount of illegal file sharing that is thought to be taking place. This is based in part upon the decline in their revenues after years of increases. Customers simply say that the copyright holders are charging too much, not providing the product in the manner that they would buy and generally not providing good product while locking out smaller market artists. Several studies have been made to verify what the real situation is. None are definitive but the result is most likely all the above. There are indeed lost sales. The copyright holders did not have the ability to obtain some types of sales in the first place. One of these sales types is the single song of an album (CD) for which Apple has demonstrated a large market. Another is the sale by the purchaser of the copyrighted material to another person. This secondary sale, if accompanied by the original physical media, such as shown in FIG. 1, is legal and the copyright holder receives no compensation. If the original purchaser retains a copy for his own use, as shown in FIG. 1B, it is probably undetectable and unenforceable (and probably legal under the DMCA).

However, the sale of the physical CD or DVD is perfectly legal and supported by Amazon, eBay and others who do not allow file transfers as sale deliverables for the same copyrighted work. The seller is compensated, and the buyer pays something. Amazon or eBay receive a fee, but the copyright holder gets nothing for the secondary sale. This has the potential to halve the copyright holders' revenue. The file sharing on the peer-to-peer networks is the extension of this idea without the money changing hands.

At issue here is extraordinarily low marginal cost of producing a copy of the digital original and the similarly extraordinarily low marginal cost of distributing that copy widely.

The following facts are pertinent to the state of the digital media industry:

In a single week of 2004, about 1.5 million people downloaded the popular KaZaA file-sharing software, according to Download.com, a software aggregation site owned by CNET Networks Inc. A new survey by the Pew Internet & American Life Project showed the number of people who say they download music, both legally and otherwise, swelled to 23 million from 18 million since the group's last survey in December.

To attract support from the music industry, Fraunhofer-Gesellschaft, Munich, Germany, will license its LWDRM™ technology with a free and fully integrated online store. Whereas big record companies will probably want to develop their own shops, smaller labels could possibly shy away from the investment. Fraunhofer also promises a fully integrated digital-payment system will come with LWDRM. It will be demonstrated next spring. One hurdle needs to be overcome to make LWDRM operational: The digital certificate that consumers can download must be provided by an independent certification authority. In Fraunhofer's view, there would be several of these authorities, such as the German post office, the Bundespost, or a commercial company like VeriSign. At the moment Fraunhofer has not made a final decision about its certification partners, but will do so before the end of next summer.

OD2 has announced it will sell downloads for an average price of 50 pence per track on its five largest download sites including those run by partners Wanadoo, Tiscali, Coca-Cola, Virgin Megastores and Microsoft's MSN.

Napster has indicated it intends to develop customized services for British universities and a promotional alliance with retail chain Dixons.

In January, 2004 at least 230 online music stores were in operation. The digital music market was worth about $330 million last year, or about 1 percent of all music sales, a figure that will double in 2005 according to research firm Jupiter.

Consumers are flocking to online music services in record numbers, and digital music made up about 1.0 percent of total industry revenues in 2004, and industry estimates expect it to double in 2005 and reach 25.0 percent within five years.

### SUMMARY OF THE INVENTION

Briefly stated, the present invention provides a structure for allowing the commercial exchange of copyrighted digital media files (and other files where there is a fee due to the owner). This structure will compensate the copyright owner and the seller completely within the existing laws. An exchange service, referred to as the “Digital Copyright Exchange” or DCE will provide the smooth transition and incentive for the elimination of illegal file sharing. The types of files include, but are not limited to, music, movies, books, software, games and photos. The Digital Copyright Exchange will be paid a small fee for each file exchange, and will verify for all parties involved in the transaction that it is legal, that the exchanged file is correct and without faults, and that the payment has being correctly made to all properly represented parties. The DCE provides a structure to facilitate the legal transfer of assets and money.

The foregoing and other objects, features, and advantages of the invention as well as presently preferred embodiments thereof will become more apparent from the reading of the following description in connection with the accompanying drawings.

### BRIEF DESCRIPTION OF THE DRAWINGS

In the accompanying drawings which form part of the specification:

FIG. 1A is an illustration of a prior art transaction for the sale of a compact disc (CD) or digital video disc (DVD);

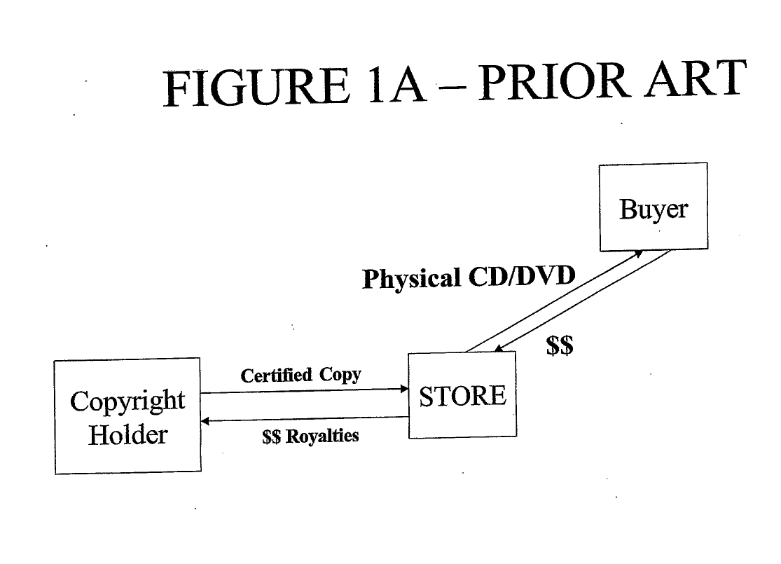

FIG. 1B is an illustration of a series of prior art transactions for the sale of duplicated compact discs (CDs) or digital video discs (DVDs);

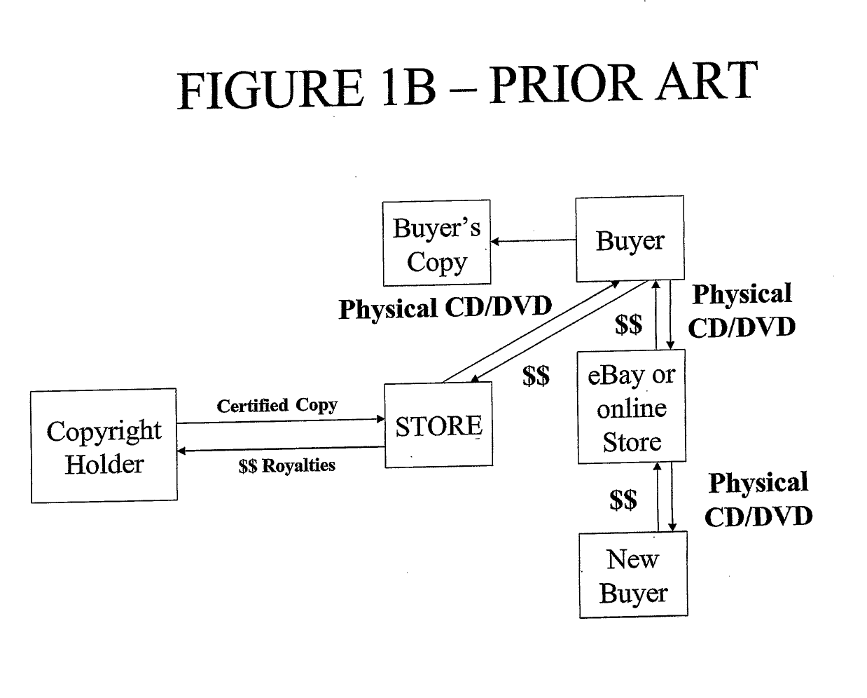

FIG. 2 is an illustration of a prior art transaction for the sale of a digital media file via the Internet;

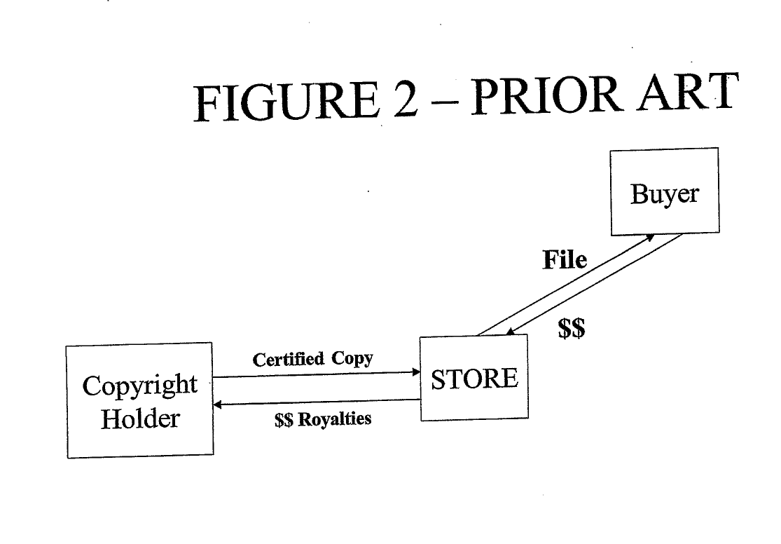

FIG. 3 is an illustration of the interaction between parties involved in the sale of a digital media file through an embodiment of the present invention;

FIG. 4 is a variation of the interaction of FIG. 3, incorporating an internet store;

FIG. 5 is a variation of the interaction of FIG. 3, generalized to any owner of a digital media file;

FIG. 6 is a variation of the interaction of FIG. 3, illustrating resale of a digital media file by a previous purchaser;

FIG. 7 is an illustration of the interaction between parties involved in the sale of a digital media file through an variation of the present invention including copyright-sales referrals;

FIG. 8 is an illustration of the interaction between parties involved in the sale of a digital media file through an variation of the present invention without copyright-sales referrals;

FIG. 9 is an illustration of the interaction between parties involved in the sale of a digital media file through an variation of the present invention including peer-to-peer network participants;

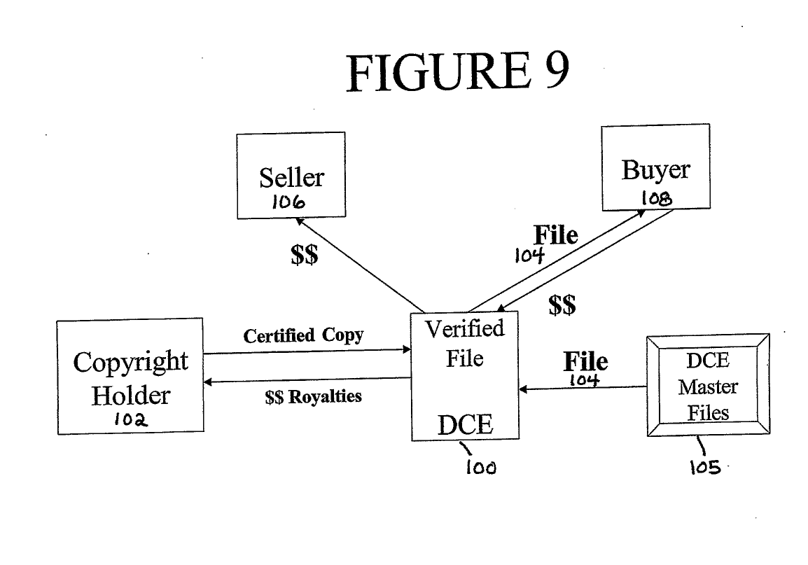

FIG. 10 is an illustration of the interaction between parties involved in the sale of a physical media through an alternate embodiment of the present invention;

FIG. 11 is an illustration of a peer-to-peer network integrated with an embodiment of the present invention;

FIG. 12 is an illustration of the interactions between the parties shown in FIG. 11 during the sale of a digital media file;

FIG. 13 is an illustration of the availability of digital media file indexing in the present invention;

FIG. 14 is an illustration of an embodiment of the present invention incorporating a locker element associated with physical media;

FIG. 15 is an illustration of an embodiment of the present invention substituting for a peer-to-peer network; and

FIG. 16 is an illustration of an embodiment of the present invention facilitating bid/offer transactions, settlement, and transfer of digital media via the Internet.

Corresponding reference numerals indicate corresponding parts throughout the several figures of the drawings.

### BRIEF DESCRIPTION OF THE APPENDICES

The accompanying appendices form part of the specification:

Appendix 1 is a listing of published articles and news stories, together with associated hyperlinks, which are related to the general subject matter of the present invention;

Appendix 2 is a listing of resources accessible via the internet which are related to the general subject matter of the present invention; and

Appendix 3 is a listing of internet web sites, together with associated hyperlinks, which are related to the general subject matter of the present invention.

### BEST MODES FOR CARRYING OUT THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

The operation of the present invention is an extension of the use of available technology organized in a way to accommodate the changes that are taking place in the transfer of ownership of digital media. There are many examples of similar successful extensions in other industries like Amazon, eBay, on line security brokers like Datek, automated security exchanges like Island and International Security Exchange (ISE). Inexpensive and free software and operating systems like Linux would not exist without the existence of the Internet for collaboration, production, marketing, distribution and customer service. In each of these cases the previous organizations or competitors did not cease to exist, they changed and found their place in the reorganized order of things. As in all other industries the Digital Copyright Exchange (DCE) exchange system of the present invention can flourish in a marketplace with many competitors similar to the other referenced participants.

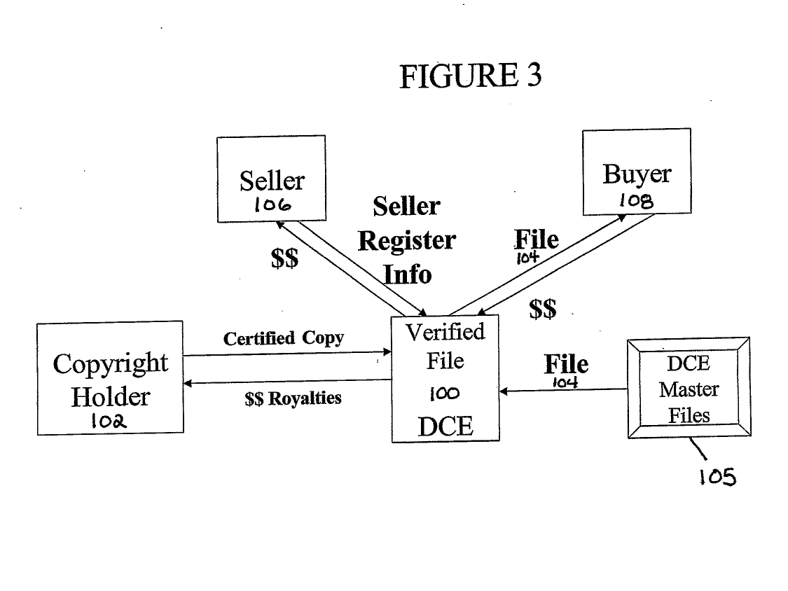

Turning to FIG. 3, the exchange system of the present invention, generally referred to as the Digital Copyright Exchange (DCE) and shown at 100, contracts with a copyright owner 102 to obtain a correct verifiable file copy 104 of a digital media, which is stored in a database of master files 105, as well as the resale lights in much the same manner as Apple and other current file exchange systems. The agreements will have additional rights however. These additional rights will allow the Digital Copyright Exchange to provide a platform through which a current holder or seller 106 of a verified original file 104 can resell that file 104 to a purchaser or buyer 108 under the condition that the copyright holder 102 and the seller 106 are paid in the transaction. This provides an entirely new and expanded method for the copyright holder 102 to be paid for remotely produced copies and distribution at no cost to the copyright holder 102. The Digital Copyright Exchange service 100 will receive a small fee on each transaction.

The incentive for the reseller 106 (the purchaser of the original copyrighted media) is to receive compensation with little or no cost for something that he currently gives away. Not everyone who is sharing files will participate initially. As the incentive to receive compensation and the risk of illegal activity rises more will participate. As more participate and the process becomes well established the illegal market place will diminish as the legal market place grows. Since it is legal users will have little fear of being identified, as is now the case in the peer-to-peer arena.

All current users of peer-to-peer networks, current resellers like Apple's iTunes and newcomers like Wal-Mart can participate. The easiest method to facilitate their participation is a small plug-in application to the current user application program. It is clear that one person purchasing one copy of a copyrighted work can supply the remaining retail demand in this way if every buyer 108 chooses to purchase from that verified seller 106. This is the position of Apple's iTunes currently. However, this is unlikely to occur due to the diversity of the market place in preference, service, and access. It is also clear that the price will quickly move to the most efficient location. This is good for all. It means more sales for the sellers 106 and their beneficiaries and better prices for the buyers of goods. There will be considerable adjustment on all sides. The most beneficial adjustment will be the reduction in illegal activity caused by lack of adjustment to new technology by the copyright holders 102 and the reduction in price for consumers 108 while protecting the copyright holders' rights.

History is littered with security schemes and the breaching of these schemes. A mechanical lock can be picked with simple tools. Software locks are no different. Encryption algorithms have all been cracked. The issue is how much computer power and time is needed. The (Digital Rights Management) DRM software is no different. The Apple FairPlay DRM software was cracked in India by PlayFair. The Apple iTunes 4.5 authentication scheme was cracked within 24 hours of its release.

The restriction of licensing software is a more subtle lock. This has shown to be a poor strategy even when the technology is superior also but it takes the marketplace longer to sort it out. VHS versus Beta format for video tape is a good example.

The following outline illustrates the key aspects of various embodiments of the present invention:

Standard Digital Media

A standard unique media identifier is assigned to each digital media work or file

Unique copyright holder identifier

Unique identifier for a particular work of that copyright holder

Code for type of work (not part of the unique code—a & b are sufficient)

A central media database contains a list of all copyright works with appropriate associated data provided by the copyright holder when the work is registered for trading, i.e. available for purchase.

The Digital Copyright Exchange (DCE) functions to enable commercial transactions involving the digital copyrighted material

Membership requires registration for buying and selling

Individuals

Copyright holders

Trading (advertisement of bids/offers & transactions for each media work)

Standard (set) pricing

Price discovery (the creation of a book of bids and offers)

All owners of a legal copy of a media file may participate as a seller

Clearing (Distribution to new owner)—all converted from master file (supports all past, current or future Digital Rights Management (DRM) or file type)

Downloading

Streaming

DCE Locker on line (via database entry)

Settlement (Payment of all parties—full accounting—retention of all transaction information)

Standard online payment by Buyer

Compensation of Seller (if applicable)

Compensation of Referrer (if applicable)

Compensation of all copyright holder parties

P2P index

Creating

Use the P2P indexing functions to create an index of all P2P items

Convert those items to records in a database

Publish the contents of that database for access to the Internet search engines (dependent upon the individual search engine process)

Using

Allow searching of the contents of the P2P index database by individuals with browser access to the Internet

Allow downloading of any item published in the P2P index through the Digital Copyright Exchange (DCE) to provide copyright holder compensation.

License internet search engines to index the P2P index maintaining the requirement that downloading of files proceed through the DCE.

On line applications that convert and transmit digital copyrighted files from original media to the owner's online digital locker within the DCE.

Convert information from CD/DVD media on the registered user's computer to files in the registered user's DCE locker.

Access of the registered user's media from any internet location through the DCE account of the owner.

Verification of ownership of media purchased in physical form for resale compensation.

The DCE 100 provides for standardized media identification and verification. This takes the form of issuer (copyright holder) identifier and issuer's catalog number (one assigned if the issuer has none) and type of work (e.g., picture, video, software application, game, audio file) identifier. This media identification is embedded in every work's file 104 along with a checksum that allows the verification of the file 104 as the original. Any change of the file 104 will cause the checksum not to match the original checksum amount. Every conversion of format of the file 104 will contain its own maintained checksum. All conversions of format will be created from the original highest quality master file 104 provided by the copyright holder 102 to the DCE 100 and stored in the DCE database 105. This method can be used for limited editions and each version of a work can be uniquely identified.

The DCE 100 is independent of, and supports, any file type or digital rights management activity. The right of every legal owner 102 and purchaser 108 of the digital copyrighted file 104 to become a seller 106 via the Digital Copyright Exchange 100 functions. This additional right will allow the DCE 100 to provide a platform that a current holder 106 of a verified original file 104 can resell that file 104 under the condition that the copyright holder 102 is paid in the transaction. This provides an entirely new and expanded method for the copyright holder 102 to be paid for remotely produced copies and remotely distributed files at no cost to the copyright holder 102. This is similar to the right of an owner of the physical media to sell that media but adds the payment of the royalty to the copyright holder in the transaction. Current definitions and legal precedents of copyright transactions based upon physical media are changed by the existence of the digital media do not apply to digital media and need to be changed/established for all media types.

With the standard database of copyrighted works 105 the purchaser 108, seller 106, or referrer of the digital copyrighted file 104 is compensated upon its transfer within the processes of the DCE 100 in a way that the copyright holder 102 also is compensated. This reduces the incentives to share or transfer files illegally. It also reduces the need to protect the file from reproduction for sharing or resale.

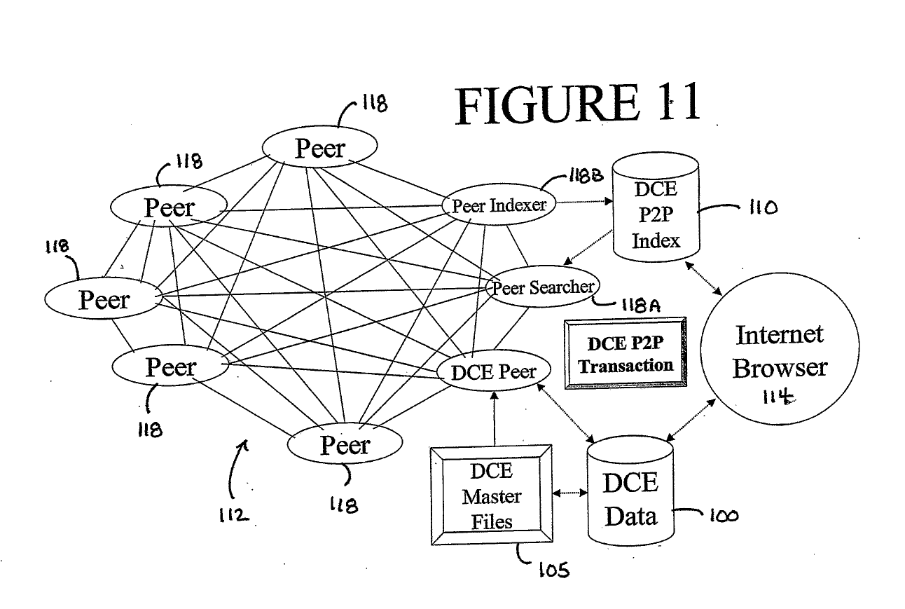

The DCE 100 processes legal copyrighted file transfer within a peer-to-peer network, as shown in FIG. 11 in addition to any other network configuration.

The DCE 100 distributes the digital copyrighted files 104 from the Exchange Master Files database 105 for the benefit of the seller 106 in lieu of the transfer of the seller's file 104 to the buyer 108. This provides for the error and corruption (of any kind) elimination in the transfer of files 104. This distribution is independent of any past, current or future Digital Rights Management (DRM) or file type. It also assures the legality of the transfer in a simple unique way. The DCE 100 is performing the functions of production and distribution. This is the basis for value for the payment of a fee to the DCE 100.

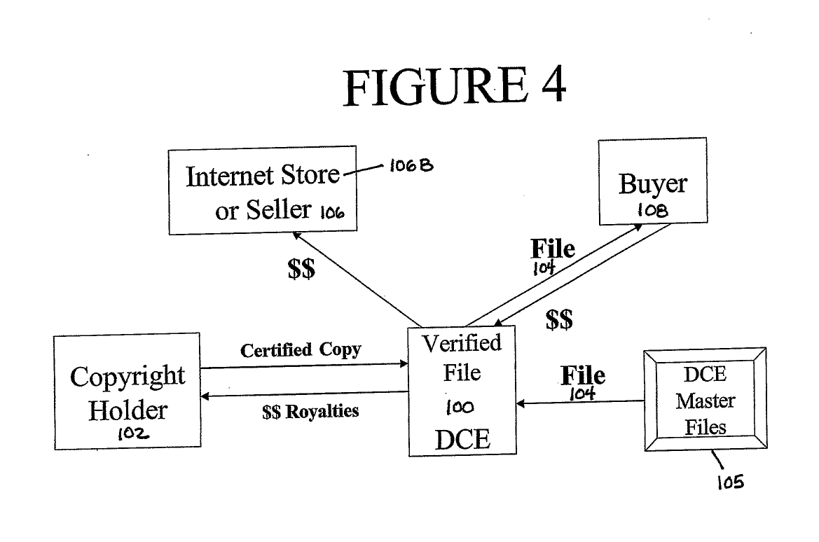

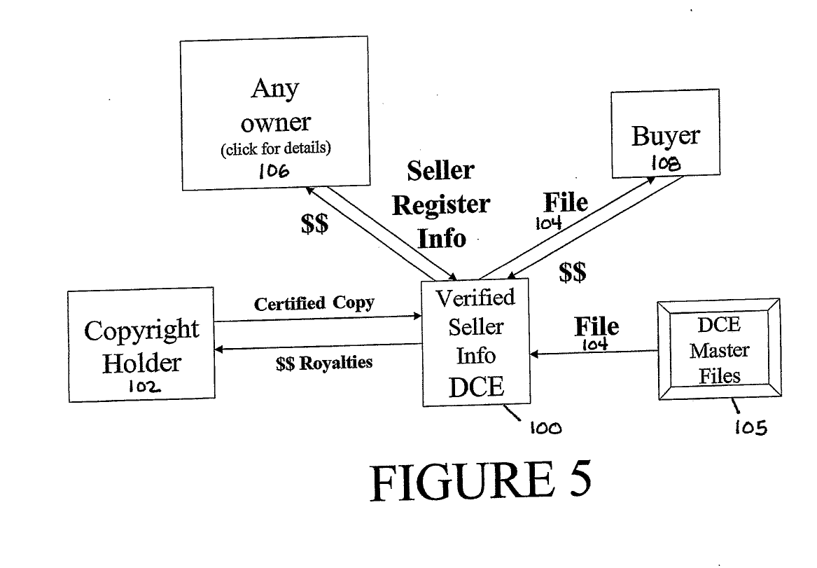

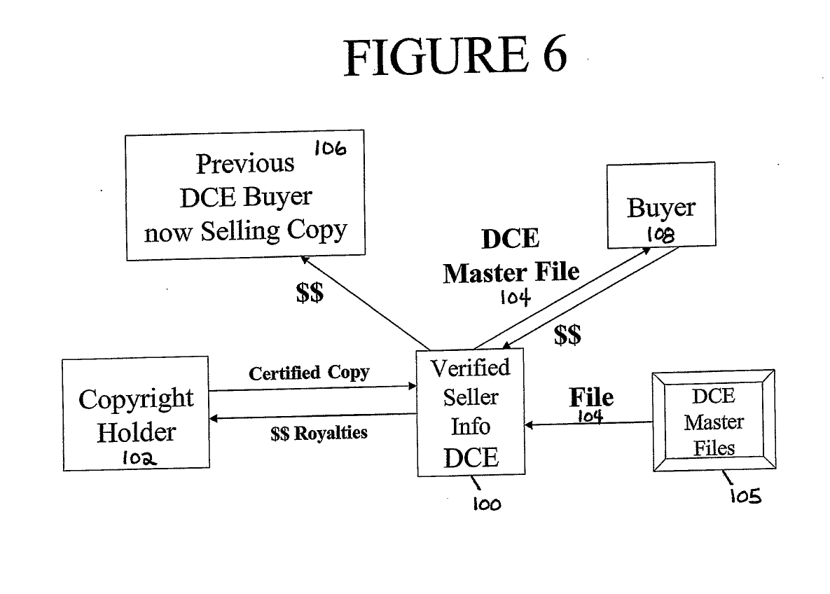

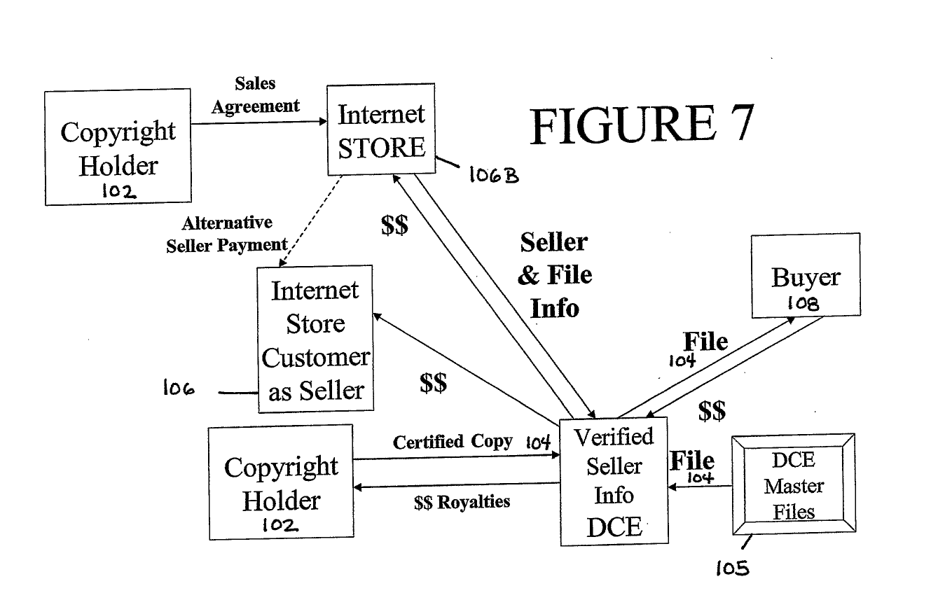

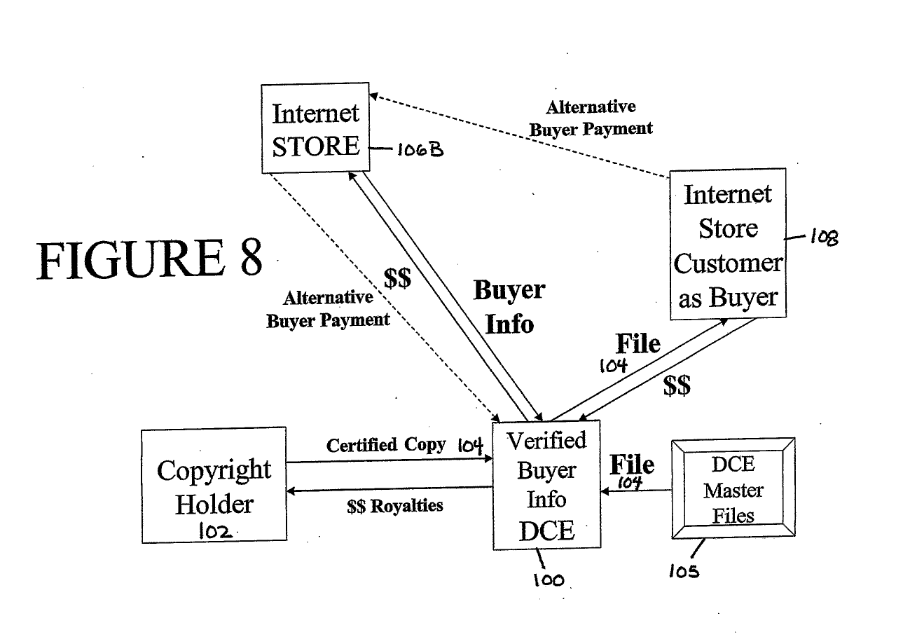

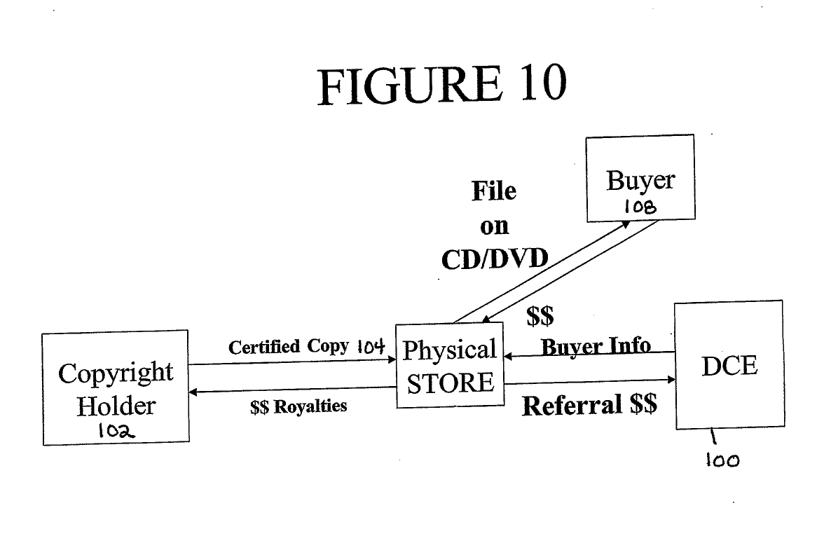

The DCE 100 will license its processes to other on-line stores 106B or legal owners 106 of copyrighted files 104, enabling access to the DCE 100 in an fully automated manner as shown in FIG. 4, expanding the number of stores or sellers through which a digital media file 104 may be sold. As shown in FIG. 5, sellers 106 of digital media files 104 may include buyers 108 who previously purchased rights to a file 104 (see: FIG. 6), internet stores and individuals with copyright-sales referrals (see: FIG. 7), internet stores and individuals without copyright-sales referrals (see: FIG. 8), peer-to-peer (P2P) network participants, and physical media sellers (see: FIG. 10). Every file exchange through the DCE 100 generates a royalty payment to the copyright owner 102.

As shown in FIG. 3, the DCE 100 will verify the legal file-ownership of a seller 106 prior to acceptance of the seller 106 as a legal reseller of the copyrighted file 104 through membership. The seller's registration information can be maintained by the DCE 100 for future reference. To ensure the integrity of files sold from a seller 106 to a buyer 108, the DCE verifies the seller's file against the master file 104 stored in the database 105. The file transferred to a buyer during a transaction is a copy from the DCE master file database 105, and not the actual file in the seller's possession, thereby reducing the possibility of transmitting incorrect files, corrupted files, or files infected with a software virus.

The DCE 100 may be configured to utilize extensible media markup language (XMML) for media exchange security and product information. For example, information associated with each digital media file may be stored in XMML format. The following is a generalized example of an XMML format, and is not intended as executable code:

<media (type=[audio|video|image|game|text|doc])

(format=[MP3|RM|JPEG|TIFF|WMA|WAV| etc . . . ])

(title=<title>)

(artist=<artist>) author

(genre=<genre>)

(studio=<studio>) publisher

(album=<album>)

(umid=<Universal Media ID(the SKU concept)>)

<download (all media attributes above)>

source=<source file name>

destination=<destination file name>(location=(tag by type or url like

ftp:\\musicvault.com\audio\ or for p2p the specific

p2p stuff like client, address, file id)

<method>=[ftp|http|p2p|bittorrent]

<upload (see above)>

<match (same as above>

<password>encrypted (purchase unlock key)

<primary copyright owner>

<composer>

<arranger>

<referrer> email & store account

<Buyer> email & store account

<Seller> email & store account

The DCE 100 performs all the functions of transfer for copyrighted digital files 104, including all the functions of an exchange applied to copyrighted digital files. These include but are not limited to legal transfer, file verification, price discovery, file delivery, money transfer. Every transfer of ownership (physical media or digital media) creates a transaction subject to payment of copyright fees. The conversion of the file 104 owned for a single owner is not a transaction. Similarly, the download of a file owned for a single owner is not a transaction. Although these types of actions are not considered transactions within the DCE 100, a record of the actions I maintained. While the DCE 100 maintains membership and registration data of sellers and/or buyers, no information on users or customers of the DCE 100 is ever provided to the copyright holders 102. Sales summary information may optionally be provided to a copyright holder 102 by the DCE 100.

As shown in FIG. 11, the DCE 100 provides mechanism for the creation of a searchable database 110 of all files 104 that exist on exposed user directories in a peer-to-peer (P2P) network 112, as well as the identification of each of these files 104 to Internet search engines and browsers 114. This brings the P2P world into the mainstream and makes it accessible to all potential users. It provides the accountability required by any commercial/legal system.

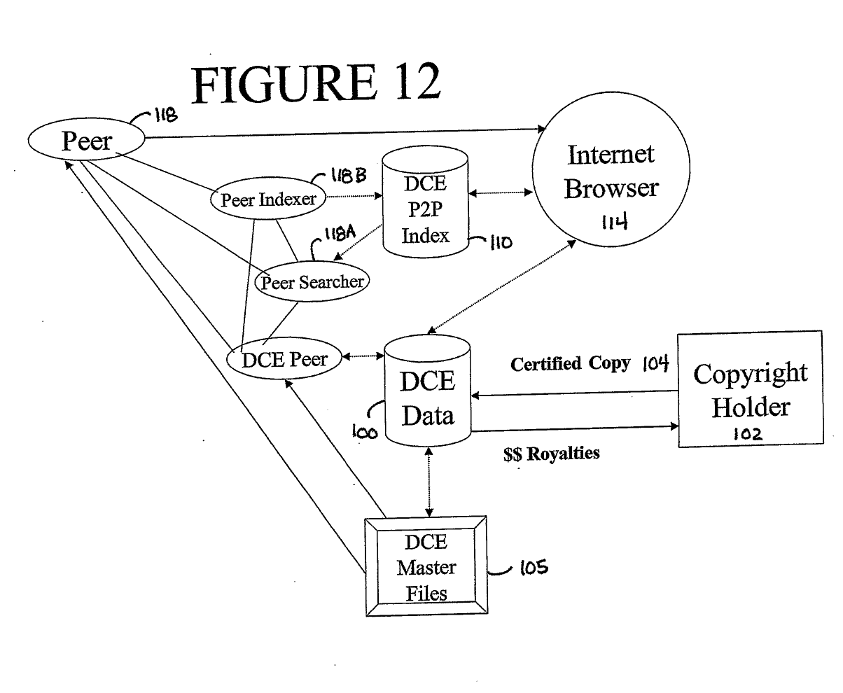

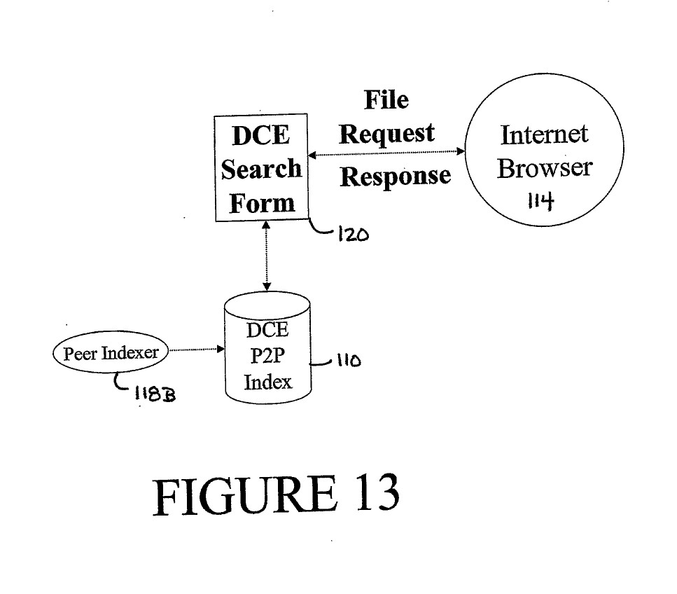

As shown in FIGS. 12 and 13, to facilitate commercial exchanges involving a P2P network, a peer indexer function 118B associated with the DCE 100 generates an index 110 of the copyrighted files on each indexed P2P network 112. A peer user 118 then provides data to a DCE search form 120 to search the DCE P2P index 110 to locate a desired file indexed on the P2P network 112 by the peer indexer function 118B. A peer searcher function 118A searches for the desired file in the peer-to-peer network 112 using the index 110 generated by a peer indexer function 118B. The peer member 118 completes the commercial transaction by registering with the DCE 100 and purchasing the desired file through the DCE 100. The purchased file is delivered from the DCE master database 105, providing a known correct and defect free file. Royalties are paid to the copyright owner 102, and a referral fee is paid by the DCE 100 to the peer member 118 offering the file on the P2P network 112. The referral fee provides an economic incentive for members of the P2P network to participate in the DCE 100.

Essentially, the function of a DCE 100 is to maintain complete and accurate records of the media 104 which is exchanged as well as complete and accurate records of the parties to each transaction. Central to any exchange is the unique identification of each item of commerce. The current on-line commerce of media (primarily music) does not have or use the same systems of SKU which serve the physical media well. These central functions assist in solving a large percentage of the problems that have been encountered by the digitization of media and the subsequent commerce associated with the transfer of ownership of this digital media. The DCE assures the transfer of ownership in a legal, efficient and sustainable manner.

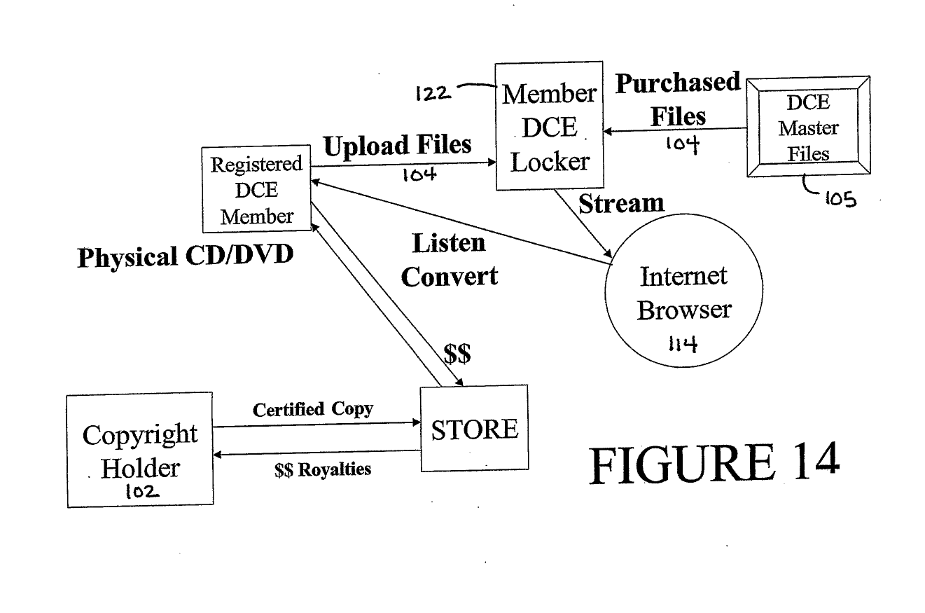

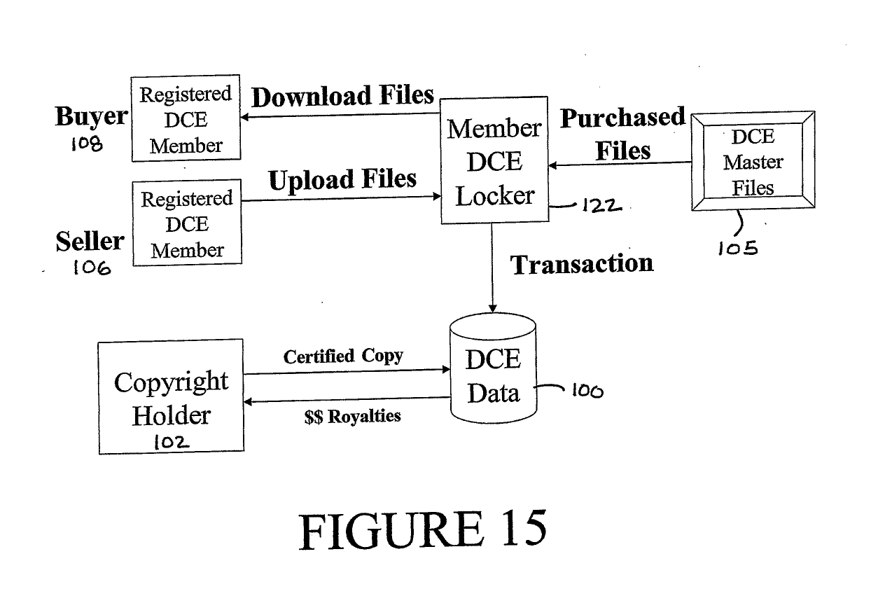

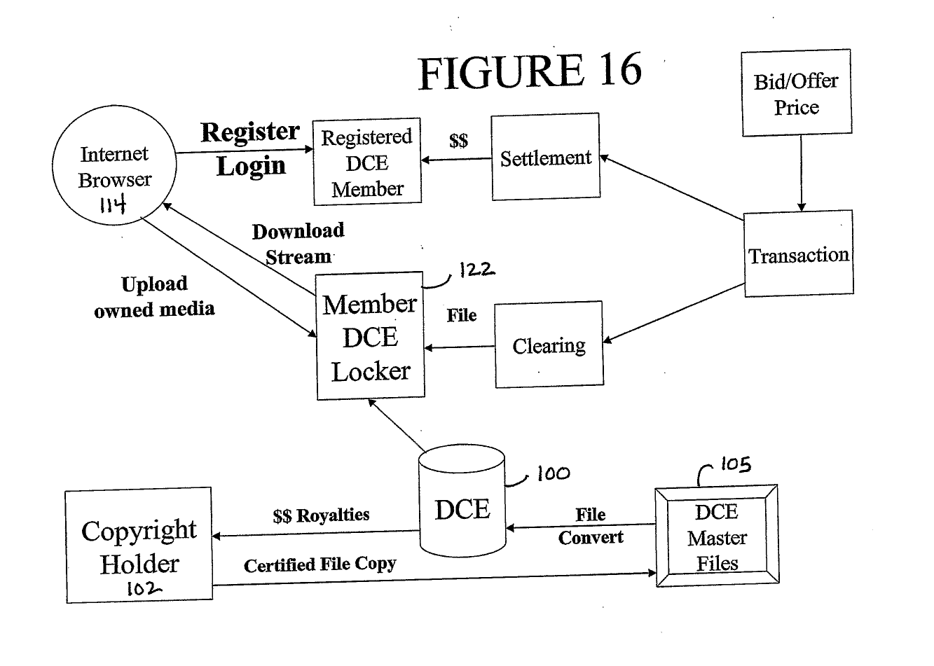

In an embodiment of the present invention shown in FIG. 14 through FIG. 16, a registered user of the DCE 100 is provided with an accessible data storage (locker) 122 for the storage of digital media data. The DCE locker 122 maintains a record or copy of known media items legally owned by the registered locker owner. The DCE 100 does no reproduce the file for items in the locker, but maintains a database record of the items contained in each locker 122.

The present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the invention.

The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A method for facilitating commercial exchange of digital media comprising the steps of:
assigning a unique owner identifier to the digital media;
assigning a unique identifier to the digital media;
providing a central media database containing a list of the owner identifiers and unique digital media identifiers;
providing an exchange interface configured to facilitate an exchange of a digital media in a commercial transaction;
transferring, through said exchange interface, a payment from a buyer to a seller upon verification of an authorized sale of said digital media;
transferring, through said exchange interface, a royalty payment to an owner associated with said authorized sale of digital media; and
distributing, through said exchange interface, a copy of said digital media from said central media database to said buyer.

2. The method of claim 1 further including the step of assigning a type-code to the digital media to identify the type of work.

3. The method of claim 1 wherein said authorized sale of said digital media is a sale of a physical media storing a copy of said digital media.

4. The method of claim 1 wherein said authorized sale of said digital media is a sale between a previous buyer of said digital media and a subsequent buyer.

5. The method of claim 1 wherein said authorized sale of said digital media is a sale of an authorized copy of said digital media between an authorized commercial reseller and a buyer of said digital media.

6. The method of claim 1 wherein said authorized sale of said digital media is a referral sale of an authorized copy of said digital media between an authorized seller and a buyer of said digital media, facilitated by an referring party; and further including the step of transferring, through said exchange interface, a referral payment to said referring party.

7. A method for facilitating commercial exchange of digital media files accessible on a peer-to-peer network comprising the steps of:
providing a central media database containing a list of digital media master files, unique digital media file identifiers, associated owner identifiers, and associated copyright owner identifiers;
maintaining a searchable index of digital media files offered for sale by members of the peer-to-peer network;
searching said index to identify a digital media file desired for purchase by a buyer;
providing an exchange interface configured to facilitate exchange of digital media identified in said searchable index and stored in said central media database;
transferring, through said exchange interface, a payment from a buyer to a seller on said peer-to-peer network upon verification of an authorized sale of a digital media file located with said exchange interface;
transferring, through said exchange interface, a royalty payment to an owner associated with said authorized sale of digital media; and
distributing a copy of said digital media to said buyer from said central media database.

8. A method for operating an online exchange system, comprising:
creating a common index of content from multiple peer-to-peer networks; and
providing an interface to said common index, said interface accessible by a standard web-browser to enable searching of said common index.

9. The use of an Exchange method for the transfer or conveyance of ownership of digital media files carrying royalty payment requirements to an associated copyright or royalty owner.

10. The use of an Exchange method for the control of the payment and ownership conditions for the transfer or conveyance of ownership of digital media files by a copyright or royalty owner in real time.

11. The use of claim 9 wherein the Exchange method includes immobilizing a physical media corresponding to the digital media files.

12. The use of claim 9 wherein the Exchange method includes providing a record of the purchase (verified ownership).

13. The use of claim 9 wherein the Exchange method enables owners of digital media files (including copyright or royalty owners) to offer their digital media for sale.

14. The use of claim 13 wherein said owners (including copyright and royalty owners) may optionally control conditions of resale of said digital media online.

15. The use of claim 9 wherein said owners can use the digital media that they own within the conditions provided by the copyright or royalty owners.

16. The use of claim 9 wherein prices for sale of said digital media can be determined by independent bids and offers as well as other criteria applied online by the copyright or royalty owner.

17. The use of claim 9 wherein copyright or royalty owners receive payment on all types of transactions (trade, donation or sale) according to what they have provided online.

18. The use of claim 9 wherein plural transaction configurations are available within the Exchange method.

19. The use of claim 18 wherein one of the plural transaction configurations is a classical store.

20. The use of claim 9 wherein the Exchange method enables multiple Exchanges to exchange information with each other for the purpose of completing transactions.
